(19) United States
(12) Patent Application Publication
(10) Pub. No.: US 2016/0098758 A1
(43) Pub. Date: Apr. 7, 2016

(54) SYSTEM AND METHOD FOR ANNOUNCEMENTS VIA A MOBILE DEVICE

(71) Applicant: Benjamin R. Hill, Leominster, MA (US)

(72) Inventor: Benjamin R. Hill, Leominster, MA (US)

(21) Appl. No.: 14/015,218

(22) Filed: Aug. 30, 2013

Related U.S. Application Data
(60) Provisional application No. 61/695,014, filed on Aug. 30, 2012.
(60) Provisional application No. 61/839,133, filed on Jun. 25, 2013.

(51) Int. Cl. G06Q 30/02

(52) U.S. Cl. CPC G06Q 30/0267; G06Q 30/0261

(57) ABSTRACT

A portable communication device and a. method for providing announcements to the portable communication device during a setup time. The method includes receiving data associated with one or more announcements in a mobile device through a communication network, detecting initiation of a function operable on the mobile device, the function being associated with a setup time, and upon detection of the initiation, providing an announcement to a user of the mobile device during the setup time. In one aspect, the announcement is an audio recording, and the setup time is a time period between a first instant when the function is initiated and a second instant when the initiated function become operational.

### CROSS-REFERENCE TO RELATED APPLICATIONS

This application claims the benefit of priority to U.S. Provisional Application No. 61/695,014, filed on Aug. 30, 2012, and to U.S. Provisional Application No. 61/839,133, filed on Jun. 25, 2013, which are incorporated herein by reference in their entirety for all purposes.

### BACKGROUND

The present disclosure relates generally to a method and a system for providing announcements to a mobile device. More particularly, the present invention relates to a method and a system for providing announcements to a mobile device during a setup time.

Mobile advertising, in which advertisers connect with consumers through their cellular telephones, personal digital assistants (PDA), and/or other mobile devices, has exploded in recent years. For example, an advertiser may encourage cellular telephone users to participate in trivia contests or enter sweepstakes, thereby opting into a marketing campaign which enables the advertiser to send those users coupons or promotional offers.

Mobile advertising is still in its infancy, however, and merchant use of mobile advertising and its many advantages has not been fully exploited. Accordingly, many more innovative and effective uses of this mode of advertising may yet be possible, particularly methods which allow advertisers to target a time when the mobile device is waiting for a function to be performed.

### BRIEF SUMMARY

In one or more embodiments of the present disclosure, the method for providing announcements to a mobile device includes receiving data associated with one or more announcements in a mobile device through a communication network, detecting initiation of a function operable on the mobile device, the function being associated with a setup time, and upon detection of the initiation, providing an announcement to a user of the mobile device during the setup time, wherein the announcement comprises an audio recording.

According to one aspect, the setup time is a time period between a first instant when the function is initiated and a second instant when the initiated function become operational. The setup time may range from about 1 second to about 60 seconds.

According to one aspect, the method further includes storing the data associated with the announcements in a non-volatile memory of the mobile device for later use. The data may include one or more identifiers respectively associated with the one or more announcements. Further, the method may include rendering a particular announcement in accordance with an identifier associated with the particular announcement.

According to one aspect, the method further include detecting a location information of the mobile device, and if the location information coincides with a geographical area information specified in an identifier of a particular announcement, rendering the particular announcement.

According to one aspect, receiving the data includes detecting a bandwidth of the communication network, and if the bandwidth is greater than a predetermined value, downloading from a remote server data associated with one or more announcements that require a storage capacity beyond a predetermined threshold.

According to one aspect, the function comprises one or more of an outgoing phone call, unlocking the mobile device, powering on the mobile device, powering off the mobile device, hibernating the mobile device, and a ringing function; and the announcements comprise video and/or audio announcements.

According to one aspect, providing the announcement includes displaying the announcement on a screen of the mobile device or playing an audio announcement using a speaker of the mobile device.

For a better understanding of the present teachings, together with other and further needs thereof, reference is made to the accompanying drawings and detailed description.

### BRIEF DESCRIPTION OF THE DRAWINGS

FIG. 1 is a schematic graphical representation of a system for providing announcements in accordance with one embodiment of the present disclosure; and

FIG. 2 is a schematic block diagram representation of a mobile device in accordance with one embodiment of the present disclosure.

### DETAILED DESCRIPTION

A portion of the disclosure in this patent document may contain material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

The following detailed description presents the currently contemplated modes of carrying out these teachings. The description is not to be taken in a limiting sense, but is made merely for the purpose of illustrating the general principles of the invention, since the scope of these teachings is best defined by the appended claims.

“Application,” as used herein in terms of an item downloaded to a mobile device, refers to a software module that, when downloaded to the mobile device and residing in a computer usable media in the mobile device and operated by a processor, causes a particular function or response.

“Setup time,” as used herein, is the time period between a time point (a first instant) when a function is initiated and a time point (a second instant) When the initiated function is operational. For example, the setup time for a cell phone call function may be the time period between a first instant when a caller initiates a phone call (e.g., when a cell phone receives a signal indicating that the caller has pressed the “call” button) and a second instant when the phone call is started and operation (e.g., when the caller begins to hear the ringback tone). The setup time may range from about 1 millisecond, typically 1 second, to about 60 seconds. In one embodiment, the setup time is, for example, 30 seconds.

In addition, a setup time may be associated with the unlock function of a smart phone. In this case, the setup time may be a time period between a first instant when a caller begins to unlock the smart phone (e.g., when the caller completes entry of a pass code, slides on an unlock GUI feature of the smart phone, etc., before the smart phone is fully operable) and a second instant when the smart phone is unlocked and fully operable (e.g., when the caller sees the home screen of the smart phone. In one embodiment, the setup time for unlocking a smart phone may be, for example, 3-5 seconds.

Further, a setup time may be associated with the powering-on, powering-off, or sleeping/hibernating functions of a communication device. For example, the setup time for powering-on a smart phone may be a time period between a first instant when a user turns on the smart phone (e.g., when the user presses the power button) and a second instant when the smart phone is powered on and operable (e.g., when the user sees the unlock screen of the smart phone). An advertisement or announcement may be displayed to a user/caller during the setup time.

“Keepalive signal,” as used herein, is a signal sent from a component to a node in a communication system to verify that the link between them is operational. “Keepalive” can be, for example, HTTP keepalive or TCP keepalive.

“Ringtone,” as used herein, refers to the sound recording played by a mobile device upon receiving an incoming call or alert.

“Ringback tone,” as used herein, refers to the sound recording another party receives when contacted by a mobile device.

“Announcement,” as used herein, refers to data or information being provided. Announcements can include advertisements, announcement of new versions of applications for updating, news, and/or other data.

In one or more embodiments of the present disclosure, a method for providing announcements to a mobile device includes receiving announcements at the mobile device; detecting initiation, at the mobile device, of a function with setup time; and providing, during the setup time, the announcements.

Embodiments of systems used in performing the above method are described below. After the description of the systems, performance of one or more exemplary embodiments of the above method is disclosed in order to further elucidate these teachings.

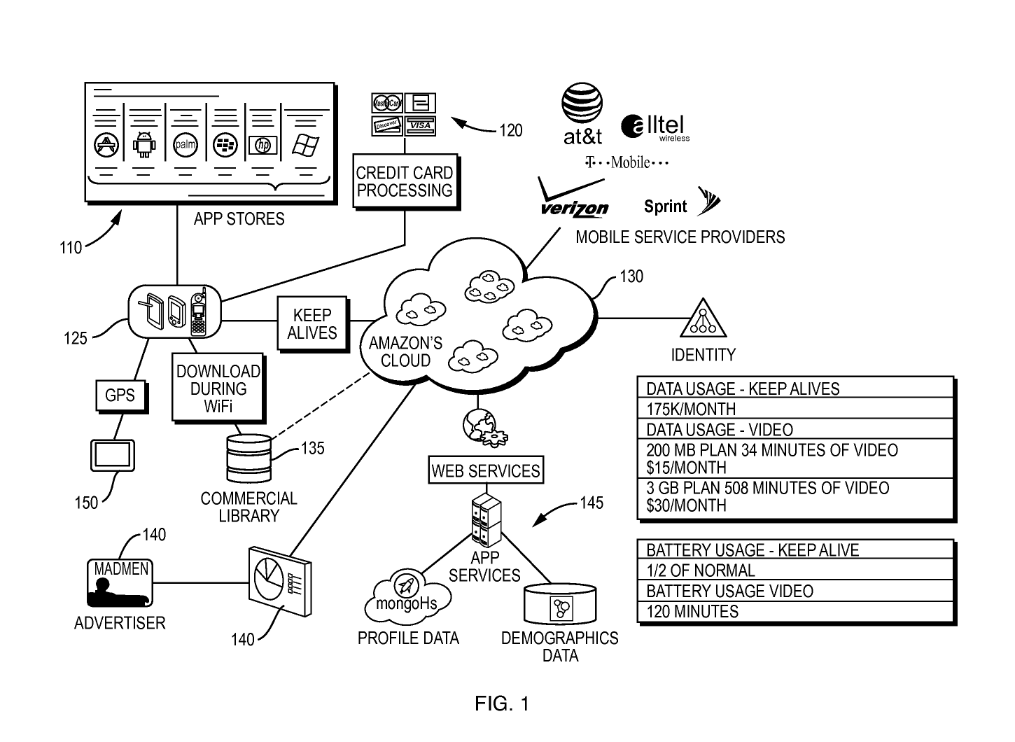

FIG. 1 illustrates a system in accordance with one embodiment of the present disclosure. Referring to FIG. 1., in the embodiment shown therein, a mobile device 125 may be adapted to download an application (or application software) from an App Store 110. Mobile device 125 may also be adapted to provide information to a processing center 120 and to a server and databases 145 through a network 130. Network 130 may be wired or wireless, and may be any form of communications system that allows mobile devices 125 to communicate with other mobile devices and/or other devices on network 130, including but not limited to server 145. Network 130 may include a global computer network, such as the Internet, private LAN, WAN, or similar networks, and/or any other form of existing network. Network 130 may also include a wireless base station, i.e., an electronic device that allows mobile devices 125 to wirelessly communicate with network 130. Wireless base station 130 may support one or more wireless air interfaces, which may include but are not limited to WiFi, CDMA, GSM, WCDMA, EDGE, and/or GPRS.

In one instance, server 145, communicating with mobile device 125 through the network 130, can implement a “keepalive” inquiry with respect to the downloaded application. The “keepalive” inquiry could be, for example, but not limited to, an HTTP keepalive or a TCP keepalive.

In one instance, a separate announcement server 140 provides announcements to use with the downloaded application. In other instances, server 140 can be combined with server 145. In yet other instances, a server or library 135 provides faster access to announcement when the connection to the network is through a Wi-Fi or similar connection which is faster than the usual connection to network 130. A location finding system 150, such as a UPS system, may provide location information for the location of mobile device 125. The location information is made available to the downloaded application on mobile device 125 so that announcements that are location sensitive can be provided.

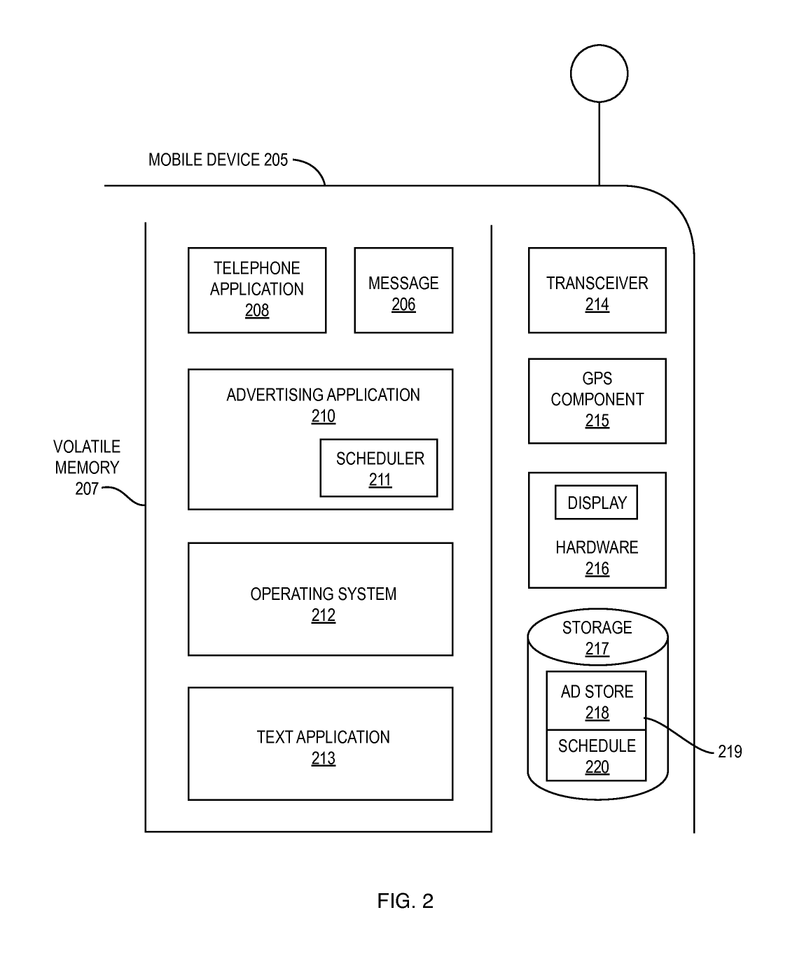

FIG. 2 illustrates a functional block diagram of a mobile device 205 in accordance with one embodiment of the present invention. Mobile device 205 includes a processor 201, volatile memory 207 (for example, RAM), a persistent storage 217, and computer-readable media (for example, disk drive, ROM, flash memory, other solid state memory technology, etc.) associated with volatile memory 207 and persistent storage 217. Computer-readable media may comprise, for example and without limitation, volatile and persistent (i.e., non-volatile) media for storage of data such as computer-readable instructions or data structures, including but not limited to DVD or other optical storage, RAM. ROM, flash memory, or any other medium, which can be used to store information and can be accessed by mobile device 205.

Mobile device 205 includes a mechanism for receiving signals (data) 206, The receiving mechanism is shown in this particular embodiment as transceiver 214 (for example, an RF transceiver), Mobile device 205 further includes a mechanism for storing data 206. As shown in FIG. 2, one mechanism for storing message 206 is announcement/advertising application 210, which includes a scheduler 211. In the embodiment shown, announcement/advertising application 210, telephone application 208, and text messaging application. 213 all run atop an operating system 212.

When transceiver 214 receives data 206, announcement/advertising application 210 receives data 206 and causes it to be stored in volatile memory 207. Data 206 can include an announcement identifier which identifies a particular announcement to be rendered. Data 206 may also include an announcement, which may be stored in announcement store 218 for later rendering, or may be rendered at the first possible instance, depending upon the specifics of data 206. Alternatively, data 206 may identify an announcement which has already been stored in announcement store 218. Data 206 may specify that the identified announcement is to be rendered at a particular time or location and/or in response to an initiating function, such as an outgoing telephone call.

Mobile device 205 may also include a mechanism for rendering the announcement identified in message 206. In the embodiment shown in FIG, 2, the rendering mechanism is announcement/advertising application 210 operating in connection with display hardware 216. Mobile device 205 may also include video hardware for rendering video announcements, or any other mechanism for communicating announcements. The illustrated embodiment further includes a Global Positioning System (GPS) component 215 for determining the position of mobile device 205. It is contemplated that UPS component 215 may be any component, for example, a Bluetooth™ application, a UPS receiver, etc., which may be used in connection with a mobile device and is capable of communicating with one or more GPS satellites, either directly or via one or more position determination entities (PDE) which assist the UPS component in locating broadcast signals from the UPS satellites.

Announcement/advertising application 210 reads data 206, and causes the announcement associated with data 206 to be rendered, at a predetermined rendering time, in the manner provided in that data. For example, data 206 may specify that the associated announcement is to be rendered in response to predetermined conditions, such as the initiation of a function with a setup time and other predetermined conditions. In that event, announcement/advertising application 210 monitors transceiver 214 and/or telephone application 208, and upon initiation of a function with a setup time, such as the initiation of an outgoing phone call, announcement/advertising application 210 then causes the announcement associated with data 206 to be rendered via display hardware 216.

In one or more instances, the data provides for rendering at least a portion thereof as sound (also referred to as a sound recording or audio recording). In those instances, the sound recording can be rendered as a ringing function (e.g., ringtones or ringback tones) of a mobile device, If the data associated with an announcement is rendered as a ringtone or a ringback tone, the setup time may then be defined as the time period during the ringing function is operational (i.e., when the ringtone or the ringback tone rings).

For example, a file in a format such as, but not limited to, MP3 can be edited using an audio program and used to provide the ringtone that is rendered from at least a portion of the data associated with one or more announcements. In another example, the sound recording can be rendered as the ringback tones. The particular ringback tone used in the rendering can be, in one instance, developed in cooperation with the wireless network owner (also referred to as the wireless carrier). The ringback tone used in rendering could, in one instance, be obtained from a custom ringback tone server as described in, for example, one or more of U.S. Pat. Nos. 7,136,679; 7,894,454; 8,085,929; and US. Patent Application Publication Nos. 2007/0286372; and 2008/0063168, the entire contents of all of which are incorporated herein by reference for all purposes. (In some instances, where the data provides for rendering at least a portion thereof as sound, an audio announcement replaces or partially replaces the ringing tone)

Announcement/advertising application 210 can include a “keepalive” component, Announcement/advertising application 210 can use the “keepalive” component to monitor whether or not the application is used on the phone. If the use of the application exceeds a predetermined threshold time, the user can be eligible for discounts or credits.

In another aspect, data 206 may include scheduler data which specifies that the announcement associated with data 206 is to be rendered in response to mobile device 206 entering a particular geographic area coinciding with the initiation of a function with setup time. Scheduler 211 then stores the scheduler data in scheduler data store 220, and instructs announcement/advertising application 210 to monitor the data received from GPS component 215. Scheduler 211 may also receive data from telephone application 208 and operating system 212 in order to determine when a function with setup time, such as a phone call, is initiating. When GPS component 215 indicates that mobile device 205 has reached the area where the announcement associated with the data 206 is to be rendered and if a function with setup time is initiated, announcement/advertising application 210 causes that announcement to be rendered. Announcement/advertising application 210 may provide the user of mobile device 205 with means to opt-in and/or opt-out from rendering announcements, or to save the announcements for later use, which may allow the user to opt-in or opt-out for a finite period of time when a function with setup time is initiated. In one particular implementation, this opt-in/opt-out feature can be used as the basis to incentivize consumers to participate in the announcement scheme. For example, discounts or credits, such as a rebate on the data plan, can be offered to mobile service subscribers that allow their mobile devices to be used in an advertising campaign.

An exemplary practice of the method, in accordance with one embodiment of the present disclosure, is presented below. Referring again to FIG. 1, a user 125 downloads the announcement/advertising application 210 (shown in FIG. 2) from an App Store 110. In one instance, user 125 provides billing information, such as credit card information. In another instance, user 125 provides identifying information. The identifying information can be used to tailor the announcements. The announcement/advertising application 210, in one embodiment, runs in the background of operating system 212. Announcement/advertising application 210 can download the announcements over time from an announcement supply 140 or a library 135, according to the preferences of the user, or the location of the user obtained from a GPS system 150. Scheduler 211 may receive notification of the start of a function that has a setup time and provide the selected announcement during the setup time. In one embodiment, user 125 has a number of options. In one instance, the options include skip and save, in which the announcements are saved for later use, or skipped and deleted, in which the announcement is deleted. In another instance, if the announcement is not skipped, the announcement plays for a predetermined duration of, for example, 30 seconds. After viewing or hearing the announcement, in one instance, user 125 has the option of saving the announcement.

The user can be provided incentives, such as a rebate on their monthly data plan. in one instance, announcement/advertising application 210 sends a keepalive signal to the network to determine that the application is being used before a rebate is provided.

For announcements where a purchase is made, announcement/advertising application 210 can cause mobile user 125 to contact a processing center 120. The same mechanism can be used to provide their rebate.

In one embodiment, the announcement has an identifying component, such as, but not limited to, a barcode. In that embodiment, when the user saves the announcement for later review, the user can, at a later time, display the announcement on the screen of the mobile device or e-mail the announcement to another device or system. In one instance, when the user displays the announcement on the screen of the mobile device or prints the announcement at another device or system, the user can present the announcement to a third-party that can identify the user or the announcement by the identifying component. Such identification is useful, for example, when the announcement is an advertisement providing a discount or a “deal,” or when the announcement is an invitation, in order to identify the person receiving the invitation.

In one instance, when mobile user 125 is in a region where faster communication service, such as WiFi, is available, announcement/advertising application 210 can request a download of announcements that require more storage (larger files that would take longer to download in slower communication services) from a library (database) 135.

Although the application has been described in respect to announcements, the present teachings can be used for providing information, such as Amber alerts or breaking news or other kinds of alerts.

For the purposes of describing and defining the present teachings, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Elements and components described herein may be further divided into additional components or joined together to form fewer components for performing the same functions.

Each computer program may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the present invention may be performed by a computer processor executing a program tangibly embodied on a computer-readable medium to perform functions of the invention by operating on input and generating output.

Common forms of computer-readable media include, for example, a floppy disk, a flexible disk, hard disk, magnetic tape, or any other magnetic medium, a CDROM, any other optical medium, any physical medium with patterns of holes, a RAM, a PROM, and EPROM, a FLASH-EPROM, any other memory chip or cartridge, all of which are non-transitory,

Although the present invention has been described with respect to various embodiments, it should be realized that the present invention may have a wide variety of further and other embodiments that fall within the spirit and scope of the appended claims.

What is claimed is:

1. A method for providing announcements during a setup time, the method comprising:
receiving data associated with one or more announcements in a mobile device through a communication network;
detecting initiation of a function operable on the mobile device, the function being associated with a setup time; the setup time being selected from a time associated with an unlock function of the mobile device, and a time associated with sleeping/hibernating functions of the mobile device; the setup time being a time period between a time point (a first instant) when a function is initiated and another time point (a second instant) when the initiated function is operational; and
upon detection of the initiation, providing an announcement to a user of the mobile device during the setup time;
wherein the announcement comprises an audio recording.

2. The method of claim 1, wherein the setup time is a time period between a first instant when the function is initiated and a second instant when the initiated function become operational.

3. The method of claim 2, wherein the setup time ranges from about 1 millisecond to about 60 seconds.

4. The method of claim 1, further comprising storing the data associated with the announcements in a memory of the mobile device for later use.

5. The method of claim 4, wherein the memory is non-volatile.

6. The method of claim 1, wherein the data comprises one or more identifiers respectively associated with the one or more announcements.

7. The method of claim 6, further comprising rendering a particular announcement in accordance with an identifier associated with the particular announcement.

8. The method of claim 6, further comprising:
detecting a location information of the mobile device; and
if the location information coincides with a geographical area information specified in an identifier of a particular announcement, rendering the particular announcement.

9. The method of claim 1, wherein receiving the data comprises:
detecting a bandwidth of the communication network; and
if the bandwidth is greater than a predetermined value, downloading from a remote server data associated with one or more announcements that require a storage capacity beyond a predetermined threshold.

10. The method of claim 1, wherein the function is one of unlocking the mobile device, powering on the mobile device, powering off the mobile device, and hibernating the mobile device.

11. The method of claim 1, wherein providing the announcement comprises playing an audio announcement using the mobile device.

12. The method of claim 1, wherein providing the announcement comprises displaying the announcement on a screen of the mobile device.

13. A portable communication device, comprising:
a processor;
memory; and
an announcement application stored in the memory and executable by the processor, the announcement application, when executed by the processor, causing the processor to perform a method comprising:
receiving data associated with one or more announcements through a communication network;
detecting initiation of a function operable on the portable communication device, the function being associated with a setup time; the setup time being selected from a time associated with an unlock function of the mobile device, and a time associated with sleeping/hibernating functions of the mobile device; the setup time being a time period between a time point (a first instant) when a function is initiated and another time point (a second instant) when the initiated function is operational; and
providing an announcement to a user of the portable communication device during the setup time;
wherein the announcement comprises an audio recording.

14. The device of claim 13, wherein the setup time is a time period between a first instant when the function is initiated and a second instant when the initiated function become operational.

15. The device of claim 14, wherein the setup time ranges from about 1 second to about 60 seconds.

16. The device of claim 13, further comprising a persistent storage for storing the data associated with the one or more announcements.

17. The device of claim 13, wherein the announcement application further comprises mechanism for rendering a particular announcement in accordance with an identifier associated with the particular announcement.

18. The device of claim 17, wherein the announcement application further comprises means to opt-in or opt-out from rendering announcements.

19. The device of claim 17, further comprising a location finding system for determining a location information of the portable communication device.

20. The device of claim 19, wherein the mechanism for rendering renders the particular announcement, if the location information coincides with a geographical area information specified in the identifier associated with the particular announcement.

21. The device of claim 13, further comprising a screen for displaying an announcement.

22. The device of claim 13, further comprising a speaker for playing an audio announcement.

23. The device of claim 13, further comprising a telephone application in the memory for initiating the function, wherein the function is one of unlocking the mobile device, powering on the mobile device, powering off the mobile device, and hibernating the mobile device.

24. The device of claim 13, wherein the announcement application further comprises a keepalive component for monitoring usage of the announcement application.

25. A computer program product for use in a portable communication device, the computer program product comprising a non-transitory storage having program code embodied therein, the program code comprising:
program code for receiving data associated with one or more announcements through a communication network;
program code for detecting initiation of a function operable on the portable communication device, the function being associated with a setup time; the setup time being selected from a time associated with an unlock function of the mobile device, and a time associated with sleeping/hibernating functions of the mobile device; the setup time being a time period between a time point (a first instant) when a function is initiated and another time point (a second instant) when the initiated function is operational; and
program code for providing an announcement to a user of the portable communication device during the setup time, wherein the announcement comprises an audio recording.
